(19) United States
(12) Patent Application Publication
(10) Pub. No.: US 2026/0032608 A1
(43) Pub. Date: Jan. 29, 2026

(54) Absolute Timing Window for Air-to-Ground UEs

(71) Applicant: Apple Inc., Cupertino, CA (US)

(72) Inventors: Jie CUI, San Jose, CA (US); Dawei ZHANG, Saratoga, CA (US); Hong HE, San Jose, CA (US); Manasa RAGHAVAN, Sunnyvale, CA (US); Qiming LI, Beijing (CN); Rolando E BETTANCOURT ORTEGA, Munich (DE); Xiang CHEN, Palo Alto, CA (US); Yang TANG, San Jose, CA (US); Yuexia SONG, Beijing (CN)

(21) Appl. No.: 19/099,970

(22) PCT Filed: Aug. 4, 2022
(86) PCT No.: PCT/CN2022/110323

§ 371 Date: Jan. 30, 2025

(51) Int. Cl. H04W 56/00; H04W 64/00

(52) U.S. Cl. CPC H04W 56/001; H04W 64/006

(57) ABSTRACT

A user equipment (UE) is configured to determine a reference point for a transmission, determine a timing window based on a moving speed of the UE, wherein the timing window encompasses at least one synchronization signal block (SSB) transmitted by a base station and perform time tracking based on detecting the at least one SSB in the timing window and the determined reference point.

### TECHNICAL FIELD

This application relates generally to wireless communication, and in particular relates to absolute timing window for air-to-ground UEs.

### BACKGROUND

Existing air-to-ground (ATG) network deployments require multiple improvements. These improvements include improved performance while operating in extremely large cell coverage ranges at high flight speeds, improved coexistence between ATG and terrestrial networks, and improved performance of ATG base stations (BSs) and User Equipment (UE).

### SUMMARY

Some exemplary embodiments are related to a processor of a user equipment (UE) configured to determine a reference point for a transmission, determine a timing window based on a moving speed of the UE, wherein the timing window encompasses at least one synchronization signal block (SSB) transmitted by a base station and perform time tracking based on detecting the at least one SSB in the timing window and the determined reference point.

Other exemplary embodiments are related to a user equipment (UE) having a transceiver configured to communicate with a base station and a processor communicatively coupled to the transceiver and configured to determine a reference point for a transmission, determine a timing window based on a moving speed of the UE, wherein the timing window encompasses at least one synchronization signal block (SSB) transmitted by the base station and perform time tracking based on detecting the at least one SSB in the timing window and the determined reference point.

Still further exemplary embodiments are related to a processor of a base station in an air-to-ground (ATG) system. The processor is configured to determine a moving speed of a user equipment (UE), determine a periodicity of synchronization signal block (SSB) transmissions based at least on the moving speed of the UE and transit SSBs based on the determined periodicity.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows an exemplary method for gradual timing adjustment logic according to various exemplary embodiments.

FIG. 5 shows an exemplary diagram for absolute timing adjustment logic according to various exemplary embodiments.

### DETAILED DESCRIPTION

The exemplary embodiments may be further understood with reference to the following description and the related appended drawings, wherein like elements are provided with the same reference numerals. The exemplary embodiments relate to redesigning UE autonomous timing adjustments in ATG operations, to be described in greater detail below. Specifically, the exemplary embodiments describe gradual timing adjustments and absolute transmission timing conditions.

The exemplary embodiments are described with regard to an ATG UE. In the exemplary embodiments, it will be described that the ATG UE is installed on an aircraft. Those skilled in the art will understand that an ATG UE installed in aircraft may be used for any number of purposes. For example, the ATG UE may be used as an alternative manner of communicating with the aircraft other than the normal air traffic control (ATC) channels. In another example, the ATG UE may act as a relay for UEs on board the aircraft so passengers may use their UEs on a flight. However, reference to an ATG UE and installation on an aircraft is merely provided for illustrative purposes. The exemplary embodiments may be utilized with any electronic component that may establish a connection to a network and is configured with the hardware, software, and/or firmware to exchange information and data with the network. Therefore, the ATG UE as described herein is used to represent any electronic component.

The exemplary embodiments are also described with reference to a 5G New Radio (NR) network. However, it should be understood that the exemplary embodiments may also be implemented in other types of networks, including but not limited to legacy networks or future evolutions of the cellular protocol (e.g., 6G networks) capable of performing ATG operations.

An ATG UE may be configured to correct transmission timing errors between the UE and a cell (e.g., a gNB). Large cell coverage (up to 300 km) and flight speeds (up to 1200 km/h) require UEs to adjust signaling timing to account for the propagation speed (c) of radio transmissions. ATG systems require more substantial error correction than terrestrial networks due to the substantially larger distances and speeds inherent to ATG operations. The coexistence of ATG and terrestrial networks necessitates improvements to UE timing performance in ATG operations.

As described above, the exemplary embodiments are described with reference to a redesign of ATG UE operations for gradual timing adjustments and absolute transmission timing conditions. With respect to the gradual timing adjustment, high UE moving speeds should be considered in the redesign of a maximum autonomous time adjustment step (T_{q}) and a minimum aggregate adjustment rate (Tₚ). T_{q} may be understood as a magnitude of a timing adjustment; and Tₚ may be understood as a rate of adjusting the magnitude of a timing adjustment (e.g., rate of changing T_{q}).

The positional awareness of the ATG UE may also be considered in the exemplary embodiments. When the ATG UE supports Global Navigation Satellite System (GNSS) and/or the ATG UE knows the location of base stations along the flight path, the ATG UE may use existing T_{q}/Tₚ operations but may update the timing change periodically or through the occurrence of a trigger event. When the UE does not support GNSS or does not know the base station location(s), the moving speed and distance moved by the ATG UE may be used to determine the Tₚ/T_{q} step. These exemplary embodiments are described in greater detail below.

With respect to the absolute transmission timing condition, the availability of synchronization signal blocks (SSB) may be redesigned in the exemplary embodiments. For example, a timing chip granularity may be defined as:

$$1 / ( Δ f / {N}_{f} ) ,$$

where Δf denotes a subcarrier spacing (SCS) size and N_{f} denotes a fast fourier transform (FFT) size. The timing chip granularity may be understood as a resolution for SSB detection.

The UE requires that SSB detection occurs during the last 160 ms before an initial ATG UE transmission. The initial transmission may be understood to be the first transmission in a discontinuous reception (DRX) cycle for a physical uplink control channel (PUCCH), physical uplink shared channel (PUSCH) and sounding reference signal (SRS), a physical random access channel (PRACH) transmission, a msgA transmission, a first transmission sent on the primary and secondary cells (PSCell) for activating the deactivated secondary cell group (SCG) without random access channel (RACH). The initial transmission may also be understood to be the transmission for PUSCH on cell group (CG) resources for small data transmission (SDT) when the UE 110 is in an RRC_inactive mode.

This may pose problems for UEs moving at high rates of speed (e.g., 1200 km/h). In an exemplary scenario, a UE moving at 1200 km/h experiences a timing drift of 0.16 s. It is possible for UEs to exceed a timing error limit from a combination of high UE moving speed and insufficient granularity of the timing resolution. Exceeding the timing error limit will negatively impact the user experience. Thus, the exemplary embodiments also redesign the availability of the SSBs to satisfy the requirement of SSB detection within the last 160 ms.

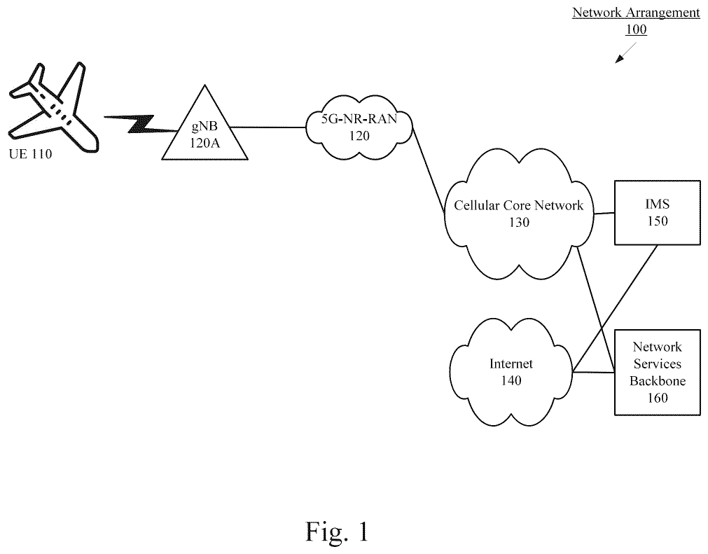

FIG. 1 shows an exemplary network arrangement 100 according to various exemplary embodiments. The exemplary network arrangement 100 includes an ATG UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IOT) devices, etc. As described above, the exemplary embodiments are described with reference to an ATG UE 110 that is installed in an aircraft. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., LTE-RAN, wireless local area network (WLAN), 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120. The UE 110 may also have other chipsets to communicate with other types of RANs, e.g., LTE chipset, ISM chipset, etc.

The 5G NR RAN 120 may be a portion of a cellular network that may be deployed by a network carrier (e.g., Verizon, AT&T, T-Mobile, etc.). The 5G NR RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., the gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

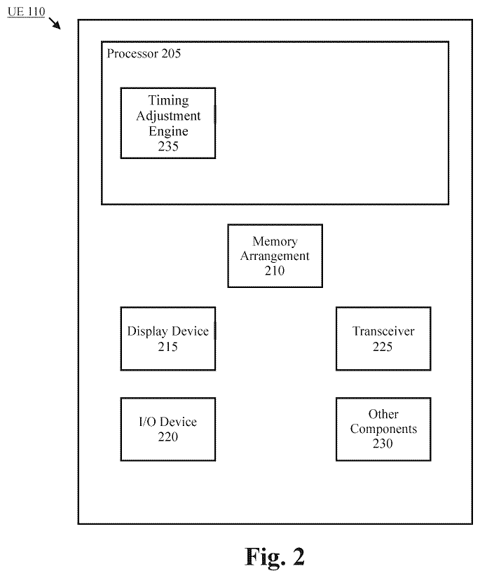

FIG. 2 shows an exemplary ATG UE 110 according to various exemplary embodiments. The ATG UE 110 will be described with regard to the network arrangement 100 of FIG. 1. The ATG UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the ATG UE 110 to other electronic devices, sensors to detect conditions of the ATG UE 110, etc.

The processor 205 may be configured to execute a plurality of engines for the ATG UE 110. For example, the engines may include a timing adjustment engine 235 for performing operations including determining a gradual time adjustment and an absolute time adjustment for the UE timing to account for a moving speed of the ATG UE 110. These operations will be described in greater detail below.

The above referenced engine being an application (e.g., a program) executed by the processor 205 is only exemplary. The functionality associated with the engines may also be represented as a separate incorporated component of the ATG UE 110 or may be a modular component coupled to the ATG UE 110, e.g., an integrated circuit with or without firmware. For example, the integrated circuit may include input circuitry to receive signals and processing circuitry to process the signals and other information. The engines may also be embodied as one application or separate applications. In addition, in some ATG UEs, the functionality described for the processor 205 is split among two or more processors such as a baseband processor and an applications processor. The exemplary embodiments may be implemented in any of these or other configurations of an ATG UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies). For example, the transceiver 225 may operate on the unlicensed spectrum when e.g., NR-U is configured.

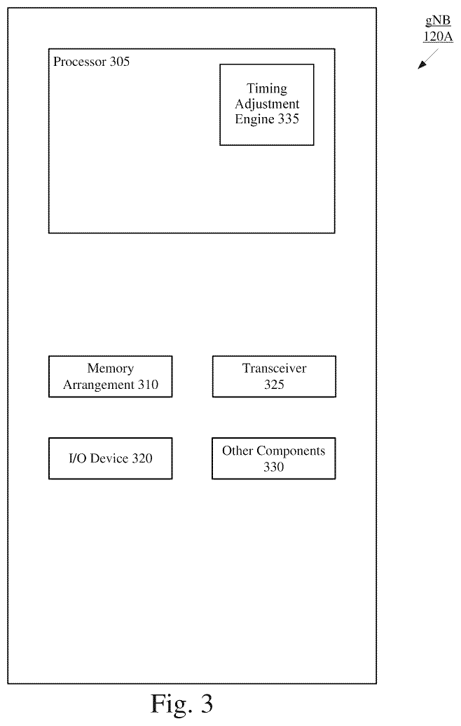

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 320, a transceiver 325 and other components 330. The other components 330 may include, for example, an audio input device, an audio output device, a battery, a data acquisition device, ports to electrically connect the base station 300 to other electronic devices and/or power sources, etc.

The processor 305 may be configured to execute a plurality of engines of the base station 300. For example, the engines may include a timing adjustment engine 335 that may perform operations related to configuring SSB transmissions based on a moving speed of an ATG UE. These operations will be described in greater detail below.

The above noted engine 335 being an application (e.g., a program) executed by the processor 305 is only exemplary. The functionality associated with the engine 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 320 may be a hardware component or ports that enable a user to interact with the base station 300. The transceiver 325 may be a hardware component configured to exchange data with the UE 110 and any other UE in the network arrangement 100. The transceiver 325 may operate on a variety of different frequencies or channels (e.g., set of consecutive frequencies). Therefore, the transceiver 325 may include one or more components (e.g., radios) to enable the data exchange with the various networks and UEs.

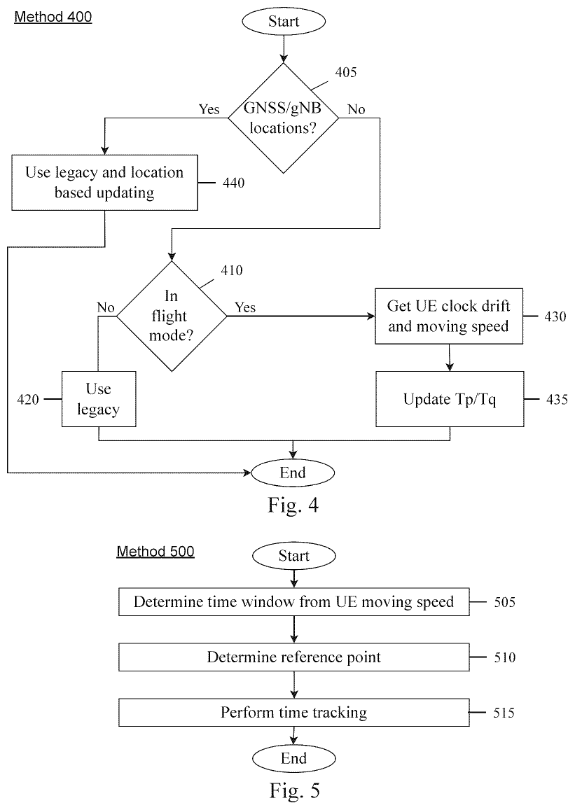

FIG. 4 shows an exemplary method 400 for gradual timing adjustment logic according to various exemplary embodiments. Prior to describing the specific operations for gradual timing adjustments for an ATG UE (e.g., the redesign of the T_{q} and Tₚ), the gradual timing adjustment logic will be described. The gradual timing adjustment logic may be used to determine when to apply the updated gradual timing adjustments and when to apply the legacy gradual timing adjustments based on capabilities of the ATG UE and/or conditions being experienced by the ATG UE. As will be described in greater detail below, in some instances, the updated gradual timing adjustments may be applied without regard to the capabilities and/or conditions.

In 405, it is determined if the ATG UE 110 supports GNSS capabilities and whether the ATG UE 110 knows the locations of the base stations of the ATG system. If both of these conditions are satisfied, in 440, the ATG UE 110 may use a legacy T_{q}/Iₚ design but periodically or event-triggered update the timing due to a location change of the ATG UE 110. This update will be described in greater detail below.

If the conditions of 405 are not satisfied, then, in 410, it is determined whether the ATG UE 110 is in a flight mode, e.g., moving at a high rate of speed. If the ATG UE 110 is not in flight mode, e.g., the ATG UE 110 is on the ground, in 420 the legacy T_{q}/Tₚ design may be used because the ATG UE 110 is operating similar to a standard terrestrial UE.

However, if the ATG UE 110 is in flight mode, then the ATG UE 110, in 430, will determine a clock drift and the moving speed of the ATG UE 110. The ATG UE 110 will use these values in 435 to update the T_{q}/Tₚ design. This update will be described in greater detail below.

It should be understood that the above described logic is only exemplary and that the ATG UE 110 may implement the legacy and/or updated T_{q}/Tₚ designs under other conditions. For example, the operations 430 and 435 may be performed regardless of whether the ATG UE 110 is in flight mode or on the ground. The logic of the method 400 is just one example of a logic that may be implemented.

Returning to the specific T_{q}/Tₚ design updates, a first scenario that may be considered is the operations 430 and 435. As shown in the method 400, this scenario may apply when the ATG UE 110 does not support GNSS capabilities or the ATG UE 110 does not include knowledge of the base station locations. In addition, as described above, the operations 430 and 435 may be used regardless of whether the ATG UE 110 is operating in a flying mode or is currently on the ground.

In this scenario, the T_{q}/Tₚ may be determined based on the clock drifting rate and the moving speed of the ATG UE 110 as these values are determined in 430. The clock drifting rate is a value that is defined for the hardware (e.g., processor) of the ATG UE 110. In this example, it may be considered that the defined clock drifting rate is 0.1 PPM (parts per million). Thus, for a given period of time (X) (e.g., X=200 ms=0.2 s), the clock drifting rate may be determined by X*clock drifting rate, which in this example is. 0.2 s*0.1 PPM=0.02 μs.

The moving speed of the ATG UE 110 may be accounted for using the formula (moving speed*Xms)/c where c is the speed of light (3e8 m/s). To provide an example, if the moving speed of the ATG UE 110 was 1200 km/h (or 333.33 m/s) and the same X=0.2 s was used, the value associated with the moving speed would be 333.33 m/s*0.2 s/3e*m/s=0.22 μs. The contributions of the clock drift and the moving speed may be added together to result in 0.02 μs (clock drift)+0.22 μs (moving speed)=0.2 4μs.

The complete formula to account for the clock drift and the moving speed for a given time window (Xms) may be expressed as follows:

Xms*clock drifting rate+(moving speed*Xms)/c

Once this value is known, it may be compared to a fundamental unit of time used in cellular timing operations. In this example, this fundamental unit of time is termed Ts. In 5G NR systems, Tₛ=32.552 ns as defined by the 3GPP Specifications. However, in other radio access technologies, the value of Ts may be different. Thus, the example of 0.24 μs calculated to account for the clock drift and the moving speed is 7.37*Tₛ. Therefore, in 435, the Tₚ/T_{q} should be designed in this hypothetical example to be no less than 7.37Tₛ.

It should be understood that the above calculations are only exemplary and an actual scenario may have different values for the various parameters accounting for the clock drift and moving speed of the ATG UE 110. In addition, it should be understood that the above calculations used a certain rounding error and significant digits in the calculations, other rounding errors and significant digits may result in slightly different values.

Also, the above example did not provide the specific values for the T_{q}/Tₚ design. It should be understood that any values may be defined for the updated T_{q}/Tₚ design as long as the values satisfy the calculated values, e.g., in this example the T_{q}/Tₚ should be no less than 7.37Tₛ.

In a first variation of the first scenario, the T_{q}/Tₚ design may include an adaptive step based on the real time speed of the ATG UE 110, e.g., the ATG UE 110 may calculate its real time speed at any given moment and use that real time speed in the above described calculations. In a second variation, the T_{q}/Tₚ design may include a fixed step based on the highest or average speed of the ATG UE 110. For example, in the above exemplary calculation, it may be assumed that the 1200 km/hr is the top speed of the ATG UE 110 and this value is used in the calculation as a worst case scenario. In a third variation, the T_{q}/Tₚ design may include relaxed values that are predefined in the standards (e.g., 3GPP Specifications).

In a second scenario, it may be considered the ATG UE 110 does not support GNSS capabilities or the ATG UE 110 does not include knowledge of the base station locations. In this second scenario, the specific T_{q}/Tₚ design may be based on whether the ATG UE 110 is in flight mode or on the ground.

When the ATG UE 110 is in flight mode, the ATG UE 110 may use the T_{q}/Tₚ design described above for the first scenario, e.g., the operations related to 430 and 435 of the method 400. On the other hand, if the ATG UE 110 is on the ground (not in flight mode), the ATG UE 110 may use the legacy T_{q}/Tₚ design for terrestrial UEs because ATG operations should not influence the adjustments. This is shown in 420 of the method 400.

In a third scenario, the ATG UE 110 may support GNSS and be aware of (or provided) the base station locations, e.g., the conditions of 405 are satisfied. Thus, in 440, the ATG UE 110 may use legacy T_{q}/Tₚ designs but may also periodically or event-triggered update the timing due to location changes of the ATG UE 110. For example, because the ATG UE 110 is aware of its own location and the location of the base station transmitting the SSBs, the ATG UE 110 will be aware of whether it is moving closer to or farther away from the base station. Thus, beyond T_{q}/Tₚ adjustments defined in the legacy behavior based on the T_{q}/Tₚ adjustment period, the ATG UE 110 may perform additional gradual timing adjustments based on the distance change between the ATG UE 110 and the base station.

This additional gradual timing adjustment may be performed periodically (e.g., at a predetermined time interval), or upon the occurrence of an event (e.g., when the ATG UE 110 updates its GNSS location, when the network triggers the ATG UE 110 to perform an update, etc.).

FIG. 5 shows an exemplary method 500 for absolute timing adjustment logic according to various exemplary embodiments. As described above, the exemplary embodiments also provide modifications for absolute transmission timing for UEs in ATG operations. The ATG UE 110 will perform time tracking on at least one SSB during the last Y ms before an initial Tx transmission. The determination of Y will be described in greater detail below.

As described above, The initial transmission may be understood to be the first transmission in a discontinuous reception (DRX) cycle for a physical uplink control channel (PUCCH), physical uplink shared channel (PUSCH) and sounding reference signal (SRS), a physical random access channel (PRACH) transmission, a msgA transmission, or a first transmission sent on the primary and secondary cells (PSCell) for activating the deactivated secondary cell group (SCG) without random access channels (RACH). The initial transmission may also be the transmission for PUSCH on cell group (CG) resources for small data transmission (SDT) when the UE 110 is in an RRC inactive mode.

In 505, the time window (Y), is determined based on the moving speed(S) of the ATG UE 110. The formula for determining Y is (Y*S)/c≤T, where c is light speed and T is the threshold of the ATG transmission (tx) timing margin based on the legacy Tₑ requirement. Those skilled in the art will understand that Tₑ is a timing error limit that is defined by specification.

In an example application of the above equation, if S =1200 km/h (or 333.33 m/s), Y*(333.33 m/s/3e8 m/s)≤ 4Tₛ for an SSB with an SCS =15kHz. As described above, Tₛ is a fundamental timing value and 4Ts is a defined value for the SCS based on the legacy Tₑ requirement. The equation reduces to Y* 11.1 μs≤0.130 μs=Y≤117 ms. Thus, in this example, Y must be less than 117 ms. Therefore, an SSB periodicity should be selected such that an SSB is transmitted in the last (Y=117 ms) before an initial transmission of the ATG UE 110. In the exemplary embodiments, it may be considered that the closest lower SSB periodicity to 117 ms is 80 ms. This step down to the closest SSB periodicity ensures that the ATG UE 110 will not miss any portion of an SSB burst due to timing window errors.

In 510, the ATG UE 110 may determine an absolute transmission timing adjustment reference point. The reference point for the UE initial transmit timing control requirement may be the downlink timing of a reference cell, minus one of two variations.

In the first variation, if the ATG UE 110 does not support GNSS or know the location of the base station, the reference point may be the downlink timing of a reference cell minus ((Nta+Nta_offset)*T_{c}). The values of each of these parameters are defined in 3GPP TS 38.133.

In the second variation, if the UE can support GNSS or knows the base station location, the reference point may be the downlink timing of a reference cell minus ((Nta +Nta_extra_Nta_offset)*T_{c}). Nta) extra is the TA value calculated based on the distance D between the UE 110 and the base station (D*2/c).

In a second option of the second aspect of the exemplary embodiments, a network-side solution for absolute transmission timing is proposed. The network may designate that the SSB periodicity shall be no greater than a predefined value.

In 515, the ATG UE 110 may perform the time tracking based on the determined values.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. In a further example, the exemplary embodiments of the above-described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

What is claimed:

1. A processor of a user equipment (UE) configured to:
determine a reference point for a transmission;
determine a timing window based on a moving speed of the UE, wherein the timing window encompasses at least one synchronization signal block (SSB) transmitted by a base station; and
perform time tracking based on detecting the at least one SSB in the timing window and the determined reference point.

2. The processor of claim 1, wherein the determination of the reference point comprises the processor further configured to:
determine a downlink timing of a reference cell, wherein the reference point is determined based on the downlink timing.

3. The processor of claim 1, wherein the determination of the reference point comprises the processor further configured to:
determine a location of the UE; and
determine a location of the reference cell, wherein the reference point is further determined based on the location of the UE and the reference cell.

4. The processor of claim 1, wherein the UE is an air-to-ground (ATG) UE.

5. The processor of claim 1, wherein the transmission is an initial transmission.

6. A user equipment (UE), comprising:
a transceiver configured to communicate with a base station; and
a processor communicatively coupled to the transceiver and configured to:
determine a reference point for a transmission;
determine a timing window based on a moving speed of the UE, wherein the timing window encompasses at least one synchronization signal block (SSB) transmitted by the base station; and
perform time tracking based on detecting the at least one SSB in the timing window and the determined reference point.

7. The UE of claim 6, wherein the determination of the reference point comprises the processor further configured to:
determine a downlink timing of a reference cell, wherein the reference point is determined based on the downlink timing.

8. The UE of claim 6, wherein the determination of the reference point comprises the processor further configured to:
determine a location of the UE; and
determine a location of the reference cell, wherein the reference point is further determined based on the location of the UE and the reference cell.

9. The UE of claim 6, wherein the UE is an air-to-ground (ATG) UE.

10. The UE of claim 6, wherein the transmission is an initial transmission.

11. A processor of a base station in an air-to-ground (ATG) system, wherein the processor is configured to:
determine a moving speed of a user equipment (UE);
determine a periodicity of synchronization signal block (SSB) transmissions based at least on the moving speed of the UE; and
transit SSBs based on the determined periodicity.

12. The processor of claim 11, wherein the moving speed comprises a real time moving speed received from the UE.

13. The processor of claim 11, wherein the moving speed comprises an average speed of the UE or a highest speed of the UE.
